(19) United States
(12) Patent Application Publication
(10) Pub. No.: US 2026/0233945 A1
(43) Pub. Date: Aug. 13, 2026

(54) Vertical Sorter

(71) Applicant: Interroll Holding AG, Sant’Antonino (CH)

(72) Inventor: Florian Funk, Hückelhoven (DE)

(21) Appl. No.: 19/530,962

(22) Filed: Feb. 5, 2026

(30) Foreign Application Priority Data
Feb. 7, 2025 (EP) 25156467.0

(51) Int. Cl. B65G 47/82; B65G 17/34

(52) U.S. Cl. CPC B65G 47/82; B65G 17/34

(57) ABSTRACT

Vertical sorter being configured to sort a conveyed item into one of a plurality of discharge areas; the vertical sorter including a plurality of conveyor carts, wherein the conveyor carts are movable in a conveying plane along a rectilinear conveying direction; wherein the conveyor carts are deflected in a rear deflection area from the conveying plane downward into a car return about a horizontal deflection axis; each conveyor cart being equipped with a discharge means, in particular a crossbelt or a pusher, the discharge means being selectively drivable to accelerate the conveyed item present on the conveyor cart in a cross direction transverse to the conveying direction; wherein a cover sheet is arranged between two adjacent conveyor carts to cover the gap between the two conveyor carts.

### CROSS-REFERENCE TO RELATED APPLICATIONS

This application claims priority to European patent application no. EP 25156467.0, filed 7 Feb. 2025; the content of which is herein incorporated by reference in its entirety.

### FIELD OF THE INVENTION

The invention refers to a vertical sorter

### BACKGROUND OF THE INVENTION

WO 2020/025329 A1 discloses a crossbelt sorter configured as a horizontal sorter. The crossbelt sorter comprises a plurality of conveyor carts arranged one behind another in a travel direction. Each conveyor cart includes a crossbelt on which a conveyed item can be placed. The crossbelt is movable in a cross direction that is oriented in a transverse direction, transverse to the travel direction. For discharging the conveyed item, the crossbelt is selectively driven, whereby, considered relative to the conveying direction, the item is laterally accelerated and conveyed off the conveyor cart (discharge). Such a crossbelt sorter is characterized by the capability to discharge items precisely even at high conveying speeds. Such crossbelt sorters are large installations that require a footprint of more than 100 square meters. To feed the conveyed item onto the crossbelt sorter, a lateral infeed is commonly used, which brings the item toward the crossbelt sorter at an acute angle relative to the conveying direction of the crossbelt sorter. Alternatively, so-called top loaders may be used, which drop the item from above onto the conveyor cart.

DE 20 2012 04 830 U1 discloses a crossbelt sorter configured as a vertical sorter. In this case, the return of the conveyor carts takes place in a plane vertically below a conveying plane for the conveyed items. All items that are placed onto the vertical sorter must be laterally discharged before the rear end or are caught at the end in a receiving area. Due to the vertical deflection, it is—unlike in a horizontal sorter—not possible to return the item in a loop back to a starting point. The conveyor carts of a vertical sorter are of similar size as in a horizontal sorter and require large deflection radii.

DE 10 2022 134 280 B3 discloses a crossbelt sorter configured as a horizontal sorter. A bellows is provided between two conveyor carts, covering the gap between the conveyor carts. The bellows exhibits high shape stability and thus sufficient supporting capability to sufficiently support and convey in the vertical direction items that were inadvertently placed in the gap region. Further sorters are described in DE 10 2017 006 213 A1, U.S. Pat. No. 11,873,166 B2, and EP 3 334 671 B1, each of which includes elaborate gap-covering means. These are configured to compensate for varying angular orientations of the conveyor carts, such as those that occur during cornering in horizontal sorters.

The conveyor carts of crossbelt sorters are dimensioned such that they can completely accommodate a conveyed item. A typical length in the conveying direction therefore is at least 15 cm, in particular at least 50 cm. Owing to the size of the conveyor carts and the associated deflection radius of the conveyor carts, the installation of a crossbelt sorter requires a large installation space. In addition, access to the crossbelt sorter must be extensively secured by fencing in order to avoid the risk of injury from the moving conveyor carts.

The present invention relates exclusively to a vertical sorter. For details concerning the distinction between a horizontal sorter and a vertical sorter, reference is made to the description of FIGS. 1a and 1b in WO 2022/122792 A2.

### SUMMARY OF THE INVENTION

It is an object of the present invention to provide an improved vertical sorter.

In one embodiment, the vertical sorter is configured to sort a conveyed item into one of a plurality of discharge areas. The vertical sorter comprises a plurality of conveyor carts. The conveyor carts are movable in a conveying plane along a rectilinear conveying direction. The conveyor carts are deflected in a rear deflection area from the conveying plane downward into a car return about a horizontal deflection axis. Each conveyor cart is equipped with a discharge means, in particular a crossbelt or a sorting pusher. The discharge means is selectively drivable to accelerate the item present on the conveyor cart in a cross direction transverse to the conveying direction.

In one embodiment, the cover sheet is suspended freely. In one embodiment, the cover sheet is fastened to two adjacent conveyor carts. This offers the advantage that the cover sheet is mounted stably and securely between the two conveyor carts. In one embodiment, the first gap distance between the two conveyor carts in the conveying plane is less than 5 cm, in particular less than 1 cm. The small distance ensures that, in the conveying plane, an item is reliably supported by the adjacent conveyor cart and does not enter the gap. It should be noted that, in a vertical sorter, the conveyor carts do not undergo lateral deflections relative to one another in the conveying plane. In particular, the gap distance is so small that a complex bellows construction cannot be installed in the gap.

In one embodiment, the second gap distance between the two conveyor carts in the deflection area is at least 5 cm, in particular at least 10 cm, and in particular at least 20 cm. In particular, the second gap distance is a multiple, in particular at least four times the first gap distance. In one embodiment, the conveyor carts are guided in the rear deflection area along a deflection radius of at least 0.5 m. In one embodiment, a receiving area is provided at the rear deflection area, into which the item is inevitably conveyed if it has not been sorted into a discharge area while being conveyed in the conveying plane. In one embodiment, the cover sheet is formed from an flexible material. In one embodiment, the cover sheet is in a tensioned state in the deflection area and in a relaxed state in the conveying plane.

The vertical sorter according to the invention is characterized in particular by one or more of the following advantages. The cover sheet can prevent dust, dirt, or other contaminants from entering the gaps between the conveyor carts. This can reduce maintenance costs and extend the service life of the installation. The cover sheet serves in particular as an additional safety measure by preventing small objects from entering the gap. An elastic cover sheet can help dampen the noise generated by the operation of the conveyor carts. This can make the working environment more pleasant and safer for employees. The cover sheet provides a more cost-effective and better-suited alternative to the known bellows for gap covering in vertical sorters.

In particular, the second gap distance is at least three times greater than the first gap distance. In particular, the second gap distance is at least 10 cm. In particular, the first gap distance is at most 5 cm. Due to the very small gap distance in the conveying plane and the much larger gap distance in the deflection area, the use of a bellows (see, e.g., DE 10 2022 134 280 B3) is not advantageous here; moreover, a bellows is rather expensive.

### BRIEF DESCRIPTION OF THE DRAWINGS

The invention will be explained in more detail below with reference to the figures; in which:

FIG. 1 shows a conventional crossbelt sorter configured as a vertical sorter schematically a) in a side view and b) in a top view;

FIG. 2 shows the rear deflection area of the conventional crossbelt sorter of FIG. 1 in a side view I two situations.

FIG. 3 shows the rear deflection area analogous to FIG. 2 of a crossbelt sorter according to the invention in a side view.

### DETAILED DESCRIPTION OF THE INVENTION

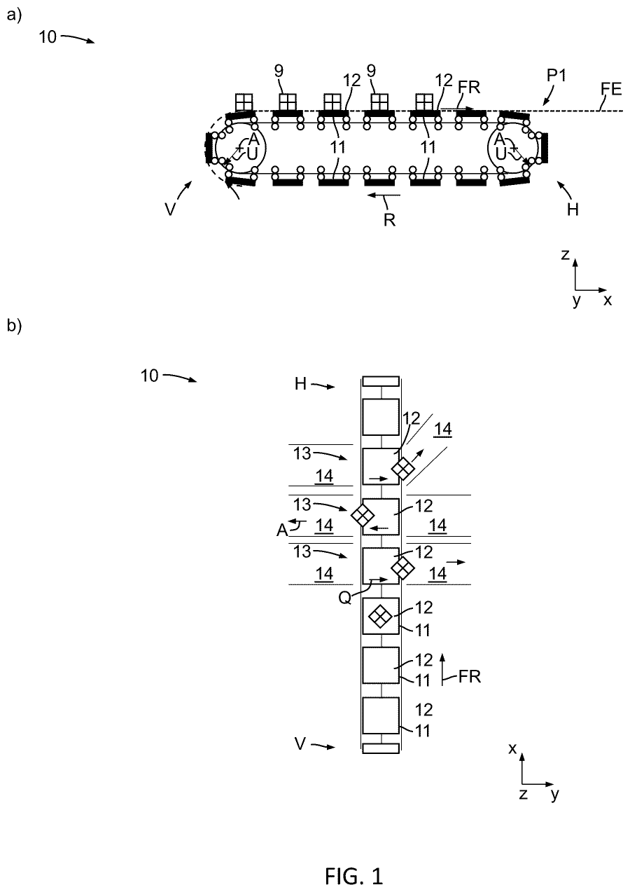

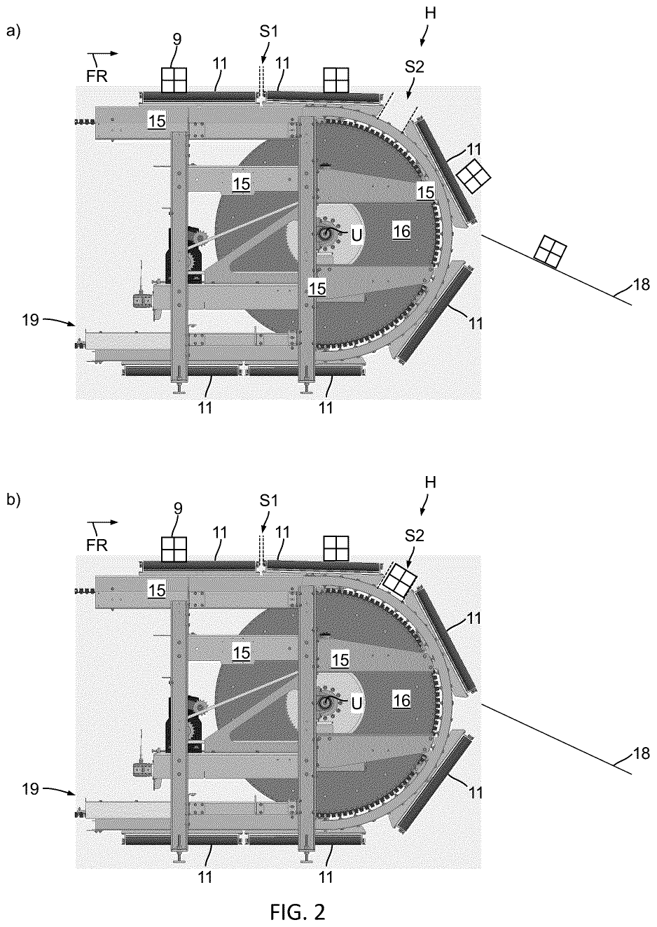

FIGS. 1 and 2 show an embodiment of a conventional crossbelt sorter 10 configured as a vertical sorter. It comprises a plurality of conveyor carts 11 that are drivable in a conveying direction FR and are arranged one behind another along the conveying direction FR. A crossbelt 12 is arranged on top of each conveyor cart 11. An upper side of the crossbelt 12 forms a support surface for a conveyed item 9 and at the same time defines a conveying plane FE. In intended use, a smallest possible item 9 rests on at most one conveyor cart 11 and one crossbelt 12. An oversized item 9 may rest simultaneously on two or more conveyor carts 11 and/or crossbelts 12. Each conveyor cart 11 has a length in the conveying direction of at least 50 cm. The conveyor carts 11 are guided on rails of a frame 15 not shown in further detail here.

At a discharge station 13, the crossbelt 12 of an individual conveyor cart 11 can be selectively accelerated in the cross direction. An item 9 resting on the conveyor cart 11 is then conveyed laterally by the crossbelt 12 into a discharge area 14, thereby implementing the sorting operation.

Typically for a vertical sorter, the conveyor carts 11 are deflected downward at a rear deflection area H from the conveying plane FE toward a car return 19, in particular along a deflection pulley. The deflection takes place about a deflection axis A which is oriented horizontally and transverse to the conveying direction FR and is located below the conveying plane FE. A deflection radius is at least 0.5 m. At a front deflection area V, which may be formed essentially identical to the rear deflection area H, the conveyor carts 11 are deflected upward toward the conveying plane FE.

Items 9 that are not discharged along the conveying plane FE reach the rear deflection area H together with the conveyor cart 11. When the conveyor cart 11 is deflected downward, the item 9 initially follows the downward movement of the conveyor cart 11 and then strikes a receiving area 18 arranged behind the rear deflection area H, which in the present case may comprise a receiving chute 18.

The conveyor carts 11 exhibit such a small distance from one another in the conveying plane FE that a first gap distance S1 in the longitudinal direction between two conveyor carts 11 is so small that an item 9 cannot enter the gap between conveyor carts 11. Due to the geometry, however, a second gap distance S2 between two adjacent conveyor carts 11 in the rear deflection area H is many times larger than the first gap distance S1, whereby, depending on size, an item 9 could enter the gap in the rear deflection area H (see FIG. 2b).

In particular, the second gap distance S2 is at least three times greater than the first gap distance S1.

In particular, the second gap distance S2 is at least 10 cm.

In particular, the first gap distance S1 is at most 5 cm.

In regular conveying operation, the conveying speed is selected to be so high that, due to centrifugal force, the item 9 in the rear deflection area H largely follows the trajectory of the conveyor cart 11 and thus does not enter the gap between the adjacent conveyor carts 11 (FIG. 2a). However, if the conveying speed lies below a threshold speed, the aforementioned centrifugal effect diminishes and the item 9 can slip into the gap between two adjacent conveyor carts and become jammed there.

This can lead to a damage of the item 9 as well as a stoppage of the sorter 10. Likewise, the transfer of the item 9 into the receiving area 18 may fail.

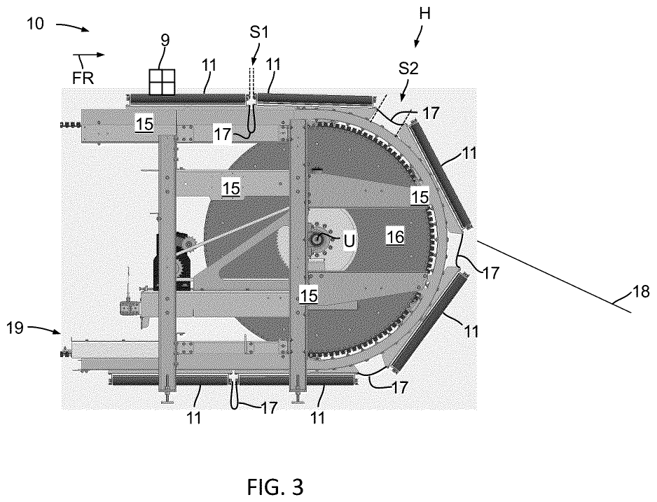

FIG. 3 shows the rear deflection area Hof a sorter according to the invention, which largely corresponds to the conventional sorter described above. In this respect, the foregoing description is also applicable to the sorter according to the invention, provided that individual aspects do not conflict therewith. Accordingly, only the deviations are described below.

In the sorter ## according to the invention, a cover sheet 17 is fastened to two adjacent conveyor carts 11 and thus covers the gap between the adjacent conveyor carts. The cover sheet 17 is in particular suspended freely.

When the conveyor carts 11 are in the conveying plane FE or in the car return 19, the cover sheet 17 hangs slack. In the rear deflection area H the cover sheet is tensioned and prevents an item 9 from entering the gap S2 between the conveyor carts 11.

The cover sheet 17 may be formed from an flexible material and may exhibit a certain tension in the tensioned state.

Because the conveyor carts 11 do not pivot laterally relative to one another in the conveying plane FE, the conveyor carts 11 can lie almost flush against one another in the conveying plane FE. The supporting capability of a bellows mentioned at the outset (see DE 10 2022 134 280 B3) is therefore dispensable in a vertical sorter.

### LIST OF REFERENCE SIGNS

9 item to be conveyed
10 vertical sorter
11 conveyor cart
12 crossbelt
13 discharge station
14 discharge area
15 frame
16 deflection pulley
17 cover sheet
18 receiving area
19 car return
S1 gap outside the deflection area, first gap distance
S2 gap within the deflection area, second gap distance
FR conveying direction
FE conveying plane
Q cross direction
A deflection axis
U deflection radius
V front deflection area
H rear deflection area

What is claimed is:

1. Vertical sorter (10),
the vertical sorter (10) being configured to sort a conveyed item (9) into one of a plurality of discharge areas (14);
the vertical sorter (10) comprising a plurality of conveyor carts (11),
wherein the conveyor carts (11) are movable in a conveying plane (FE) along a rectilinear conveying direction (FR);
wherein the conveyor carts (11) are deflected in a rear deflection area (H) from the conveying plane (FE) downward into a car return (19) about a horizontal deflection axis (A);
each conveyor cart (11) being equipped with a discharge means (12), the discharge means being selectively drivable to accelerate the conveyed item (9) present on the conveyor cart (11) in a cross direction (Q) transverse to the conveying direction (FR); characterized in that a cover sheet (17) is arranged between two adjacent conveyor carts (11) to cover the gap between the two conveyor carts (11).

2. The vertical sorter (10) of claim 1, wherein the cover sheet (17) is suspended freely.

3. The vertical sorter (10) of claim 1, wherein the cover sheet (17) is fastened to the two adjacent conveyor carts (11).

4. The vertical sorter (10) of claim 1, wherein a first gap distance (S1) between the two conveyor carts (11) in the conveying plane (FE) is less than 5 cm.

5. The vertical sorter (10) of claim 1, wherein a second gap distance (S2) between the two conveyor carts (11) in the deflection area is at least 5 cm.

6. The vertical sorter (10) of claim 1, wherein a ratio between
the second gap distance (S2) between the two conveyor carts (11) in the deflection area and
the first gap distance (S1) between the two conveyor carts (11) in the conveying plane (FE) is at least 2.

7. The vertical sorter (10) of claim 1, wherein the conveyor carts (11) are guided in the rear deflection area (H) along a deflection radius (U) of at least 0.5 m.

8. The vertical sorter (10) of claim 1, wherein a receiving area (18) is provided at the rear deflection area (H), into which the conveyed item (9) is inevitably transported if it has not been sorted into a discharge area (14) while being conveyed in the conveying plane (FE).

9. The vertical sorter (10) of claim 1, wherein the cover sheet (17) is formed from a flexible material.

10. The vertical sorter (10) of claim 1, wherein the cover sheet (17) is in a tensioned state in the rear deflection area (H), and wherein the cover sheet (17) is in a relaxed state in the conveying plane (FE).

11. The vertical sorter (10) according to claim 1, wherein the discharge means comprises a crossbelt (12) or a pusher.
